(19) United States
(12) Patent Application Publication
(10) Pub. No.: US 2012/0028230 A1
(43) Pub. Date: Feb. 2, 2012

(54) TEACHING METHOD AND SYSTEM

(76) Inventor: Gavin Devereux, Rosyth (GB)

(21) Appl. No.: 12/845,107

(22) Filed: Jul. 28, 2010

(51) Int. Cl. G09B 19/00

(52) U.S. Cl. 434/236

(57) ABSTRACT

The invention relates to a system and method for enhancing the identification of soft-skill, self-awareness, self-esteem and confidence learning needs, the development of and monitoring of improvement in self-awareness, self-esteem and confidence attributes. A method comprises establishing a baseline measurement of self-awareness, self-esteem and confidence attributes in the individual by presenting the individual a series of self-awareness, self-esteem and confidence specific questions or statements requiring multiple choice or graded responses and recording the responses; identifying from the baseline measurement specific self-awareness, self-esteem and confidence attributes in need of improvement; optionally communicating the specific self-awareness, self-esteem and confidence attribute improvement needs identified to the individual or a teacher or coach thereto; providing to and/or facilitating the individual one or a plurality of self-awareness, self-esteem and confidence raising exercises or learning modules designed to address the self-awareness, self-esteem and confidence attribute improvement needs of the individual; establishing a revised measurement of self-awareness, self-esteem and confidence attributes in the individual by presenting the individual a series of self-awareness, self-esteem and confidence specific questions or statements requiring multiple choice or graded responses and recording the responses; and comparing the revised measurement with the baseline measurement and reporting any change.

### FIELD OF THE INVENTION

This invention relates to the field of teaching or instruction, to the selection of teaching methods and materials according to a student/class profile, to the development and to monitoring of development of student soft skills. In particular, the invention is directed to a method of teaching, a method of selecting teaching methods and materials, a method of selecting students for a study course, a method of identifying, developing and monitoring student soft skill learning development and to systems and software for facilitating such methods.

### BACKGROUND OF THE INVENTION

Teaching methods and materials currently used in schools and other educational institutions are primarily directed toward achieving a specified curriculum, follow a prescribed approach (the degree to which the prescribed approach is followed depends in part on the school and the creativity of the teacher) and are driven by achieving target rates of examination passes.

There is a growing body of evidence that students who underperform in such an approach do so not simply because of lack of academic ability but additionally or instead because the approach to teaching is not aligned with their approach to learning and/or because their motivational or emotional drivers are not tapped by a traditional prescribed teaching method.

Further, this linear approach to teaching can lead to a linear approach to further education or career choice where direction in such choices are primarily from patterns of academic success without proper regard and student self-assessment for personal skills and characteristics such as self-esteem, motivation, confidence and emotional intelligence.

For example, students, especially from tough realities or inner-city/urban-aided schools, who can demonstrate traits in common with adult entrepreneurs in terms of their behaviour and attitudes are often identified by teachers as pupils who are disruptive and non-compliant and are largely unresponsive to the linear and prescribed teaching styles offered by educational institutions.

Such students tend to be sidelined by methods of instruction in schools, with the implication that they are less good than other students leading to low self-esteem lower confidence and subsequent further underperformance.

There is a need for enhanced teaching methods and course/career selection methods that address the fact that not all students behave and are motivated in the same way. There is further a need for a method for developing soft skills in the educational environment that can be readily monitored for progress.

Online and computer-assisted teaching and educational methods have been developed.

U.S. Pat. No. 6,386,883 describes a computer-assisted teaching system that can allow large centralised schools with diverse curriculum to provide distance learning to students who otherwise will need to travel. The system comprises a repository of lessons accessible by a programmed central processing unit, referred to in U.S. Pat. No. 6,386,883 as a Continuous Learning System (CLS)—a commercially available information management system, to which remotely located students may log-in to over a network. Through the CLS, students can access a number of commercially available teaching programmes and testing programmes which are presented interactively to the students. The CLS provides enhanced teaching and testing effectiveness by use of a profile generated for each student, which profiles are a description of the present educational status (e.g. year 3, month 2—used to assist CLS in selecting teaching material for the student), the educational needs (i.e. the instruction needed by the student as determined by the school's curriculum) and the educational characteristics (i.e. the manner of teaching to which the student best responds—preferred learning styles) of the student. The preferred learning styles (e.g. some students can understand mathematical theories directly from the mathematical statements or formulae while others respond to application of the theory to examples) are ascertained by a combination of student-counsellor interviews, computer-assisted examination of the student and standard psychological assessment. The profile is automatically updated following each learning session.

According to U.S. Pat. No. 6,386,883, a single lesson may be presented in a different manner to different students according to different learning styles, or to the same student in different manners if, for example, the student's learning style changes, they fail to grasp (as determined by a test) the lesson or in case the learning style does not apply to the user being taught. If, after several attempts, the student fails to demonstrate mastery of the topic, the system arranges a video conference between the student and a subject matter expert or teacher to provide coaching.

Instructional activity and selection of lessons according to a profile is organised by an intelligent administrator, being a system of programs and computer objects in U.S. Pat. No. 6,386,883. U.S. Pat. No. 6,386,883 appears to provide a method of displacing a teacher in distance learning delivery of a school's curriculum where the teacher might otherwise adapt the presentation of a lesson to allow for different learning styles and/or re-present a lesson where it is apparent to the teacher that the student does not grasp the lesson being taught.

Whilst some attention is paid to learning styles by allocating the student one of three streams according to learning styles, there is no indication of use of learning behaviours or learning motivations to develop class-based teaching and nor is the student or teacher or parent empowered to make decisions about educational or career choices suited to the student nor to facilitate face-to-face teaching styles. Finally, there is no facilitation of soft skills development or learning needs analysis or learning improvement feedback proposed by the method.

### PROBLEM TO BE SOLVED BY THE INVENTION

It is an object of the invention to provide an educational tool to understand, develop and monitor a student's or student group's self-awareness attributes, especially self-esteem and confidence.

It is an object of the invention to provide an educational tool to understand, develop and monitor a student's or student group's primary learning behaviour and primary learning motivation.

It is an object of the invention to provide skills, study options and careers guidance directly relating to the individual's own personal attributes, motives and what they value in life.

It is an object of the invention to establish processes for the development of collative use of the primary learning behaviour and primary learning motivation of a student group or population.

### SUMMARY OF THE INVENTION

In accordance with a first aspect of the invention, there is provided a method for facilitating the development and monitoring of self-awareness, self-esteem and confidence attributes in an individual, the method comprising the steps of

establishing a baseline measurement of self-awareness, self-esteem and confidence attributes in the individual by presenting the individual a series of self-awareness, self-esteem and confidence specific questions or statements requiring multiple choice or graded responses and recording the responses;

identifying from the baseline measurement specific self-awareness, self-esteem and confidence attributes in need of improvement;

optionally communicating the specific self-awareness, self-esteem and confidence attribute improvement needs identified to the individual or a teacher or coach thereto;

providing to and/or facilitating the individual one or a plurality of self-awareness, self-esteem and confidence raising exercises or learning modules designed to address the self-awareness, self-esteem and confidence attribute improvement needs of the individual;

establishing a revised measurement of self-awareness, self-esteem and confidence attributes in the individual by presenting the individual a series of self-awareness, self-esteem and confidence specific questions or statements requiring multiple choice or graded responses and recording the responses; and

comparing the revised measurement with the baseline measurement and reporting any change.

In a second aspect of the invention, there is provided a system for facilitating the development and monitoring of self-awareness, self-esteem and confidence attributes in an individual user according to the above method, the system comprising

a server configured for access over a network or the interne via a personal account by a user from an interface remotely located relative to the server and comprising a processor for executing one or more programs available for access by the user, whereby responsive to a user action on its personal account the user is presented in the form of an online questionnaire comprising a series of self-awareness specific questions or statements requiring multiple choice or graded responses;

the server comprising a means for storing an initial data set submitted by the user in response to the questionnaire and one or more successive data sets submitted by the user in successive responses to the questionnaire, which initial data set and successive data sets are tagged to the user's personal account; the server and associated processor configured to, on receipt of an initial and each successive data set, identify from said data set specific self-awareness attributes in need of improvement according to a predetermined scale or matrix and providing to and/or facilitating and/or prompting the user to undertake one or a plurality of self-awareness raising exercises or learning modules designed to address the self-awareness, self-esteem and confidence attribute improvement needs of the user;

and further configured on receipt of each successive data set, produce a comparative data set according to predetermined comparison criteria and to generate a report indicating identified changes.

In a third aspect of the invention, there is provided a method of identifying an aggregate primary learning behaviour and/or primary learning motivation of a group of students, the method comprising retrieving from each student in the group responses to an online or computer network accessed questionnaire, electronically storing the responses tagged to personal accounts allocated to each student as student behavioural and/or motivational profile data, and either (or both of):

analyzing the student behavioural and/or motivational profile data for each student according to a set of predetermined criteria or predetermined matrix to categorise each student according to a primary learning behaviour and/or primary learning motivation category and determining the most common primary learning behavior and/or primary learning motivation category in the student group; or

aggregating the student behavioural and/or motivational profile data to create group profile data set (e.g. by mean, mode or median), analyzing the said aggregated group profile data set to according to a set of predetermined criteria or predetermined matrix to categorise the student group according to a primary learning behaviour and/or primary learning motivation category.

In a fourth aspect of the invention, there is provided a method of identifying an aggregate or cumulative primary learning behaviour and/or primary learning motivation of a group of individuals, the method comprising retrieving from each individual in the group responses to an online or computer network accessed questionnaire, electronically storing the responses tagged to personal accounts allocated to each individual as individual behavioural data and/or individual motivational data, and either (or both of):

analyzing the behavioural and/or motivational data for each individual according to a set of predetermined criteria or predetermined matrix to categorise each individual according to a primary learning behaviour and/or primary learning motivation category and determining the most common primary learning behavior and/or primary learning motivation category in the group; or

aggregating the behavioural and/or motivational data to create a group profile data set (e.g. by mean, mode or median), analyzing the said aggregated group profile data set to according to a set of predetermined criteria or predetermined matrix to categorise the group according to a primary learning behaviour and/or primary learning motivation category.

In a fifth aspect of the invention, there is provided a method of selecting from a plurality of individuals a group of individuals having a specified selection or spectrum of primary learning behavior and/or primary learning motivation for the purpose of assembling a training group or a work group, the method comprising retrieving from each individual in the group responses to an online or computer network accessed questionnaire, electronically storing the responses tagged to personal accounts allocated to each individual as individual behavioural and/or motivational data, analyzing the individual behavioural and/or motivational data for each individual according to a set of predetermined criteria or predetermined matrix to categorise each individual according to a primary learning behaviour and/or primary learning motivation category, storing said category data tagged to respective individuals, searching the individual category data according to specified selection or spectrum requirements, receiving a list of names corresponding to the searched data and inviting individuals from the list of names to form into a group.

In a sixth aspect of the invention, there is provided a system and/or software configured for facilitating the above methods.

### ADVANTAGES OF THE INVENTION

The invention provides a method and system by which students may enhance their self awareness, self-esteem and self-confidence and other related attributes in an educational environment by understanding their existing, skills, attributes and skill/attribute levels, and undertaking exercises or learning modules to improve such skills/attributes and by which students, teachers and schools may monitor the progress of such skill/attribute development education.

The invention further provides a means by which students, teachers and parents may better understand the primary learning behaviours and primary learning motivators of students and the impact of such learning behaviours and motivations, by which to develop learning and other soft or transferable skills in a manner consistent with or underdeveloped due to the students learning behaviour and learning motivation and monitor such development, by which teachers may identify students or groups of students according to their learning needs and select teaching programmes or patterns or students for a class to be taught in a particular style and to meet a particular learning need and by which students may make educational and/or career-related decisions that are better informed according to the student's primary learning behaviour and primary learning motivation.

### BRIEF DESCRIPTION OF THE DRAWINGS

FIG. 1 illustrates a process of the invention conducted by a user from initial login to a system;

FIG. 2 illustrates the manner of generating and comparing attribute data through visual representation according to a preferred embodiment;

FIG. 3 illustrates a system for putting the invention into effect;

FIG. 4 illustrates a process for a tutor requesting individual and aggregate user information according to pre-determined criteria.

FIG. 5 illustrates a process for selecting individuals according to primary learning motivation.

FIG. 6 illustrates a process for use of an interactive computer aided learning system.

### DETAILED DESCRIPTION OF THE INVENTION

The invention is concerned with the identification, development of and measurement of soft-skills with a particular focus on self-awareness, self-esteem and confidence attributes in an individual. The invention comprises a method, and systems and computer software for putting the method or parts thereof into effect, which method is for facilitating the development and monitoring of self-awareness, self-esteem and confidence attributes in an individual, comprising the steps of establishing a baseline measurement of self-awareness, self-esteem and confidence attributes in the individual by presenting the individual a series of self-awareness, self-esteem and confidence specific questions or statements requiring multiple choice or graded responses and recording the responses; identifying from the baseline measurement specific self-awareness, self-esteem and confidence attributes in need of improvement; optionally communicating the specific self-awareness, self-esteem and confidence attribute improvement needs identified to the individual or a teacher or coach thereto; providing to and/or facilitating the individual one or a plurality of self-awareness, self-esteem and confidence raising exercises or learning modules designed to address the self-awareness, self-esteem and confidence attribute improvement needs of the individual; establishing a revised measurement of self-awareness, self-esteem and confidence attributes in the individual by presenting the individual a series of self-awareness, self-esteem and confidence specific questions or statements requiring multiple choice or graded responses and recording the responses; and comparing the revised measurement with the baseline measurement and reporting any change.

Self-awareness, self-esteem and confidence attributes in an individual are very important in a wide variety of activities, including business, personal and educational activities. Such attributes and the awareness of such personal attributes are extremely important in decision making, whether that is about career, personal or educational matters. It is further, a very much under-emphasised field and whilst there are numerous self-help methods available to those who look, there is no reliable and reproducible method of identifying an individual's profile of attributes, developing these attributes and measuring the improvement. The present invention provides a method and system therefor.

The methods and systems of the invention find utility in a wide variety of applications, including education, business and business coaching and personal development.

Self-awareness, self-esteem and self-confidence attributes include attributes associated with a person's own view of themselves and their worth and the manner in which they interact with others. Such self-awareness, self esteem and self confidence attributes measured and developed according to the present invention may be selected from one or more of, for example, confidence, strengths awareness, self-contentedness, skills awareness, clarity of goals, motivation to achieve, can do attitude, self belief, and positivity about accomplishments. They may further include certain soft skills and self-awareness of such soft skills, such as future-imaging (i.e. the ability to visualize yourself in a future target scenario as part of establishing and achieving goals), enthusiasm and passion. They may further include field-specific soft-skills. For example, in an educational or career-development environment which would be desired to be developed and the improvement measured, such knowledge of desired study subjects, knowledge of how to prepare a CV, awareness of suitable jobs/careers, and optionally organizational skills, study skills and research techniques etc. In a business environment, such further field-specific soft-skills or self-awareness, self esteem and self confidence attributes may include, for example, job satisfaction and the alignment of personal motivations and behaviours with a corporate culture (whereby an individual can contribute to the value of a team). Further, in a personal development context, such further field-specific soft-skills or self-awareness, self esteem and self confidence attributes may include, for example, communication and understanding of others (providing for enhanced family relationships and inter-personal interactions) and the feeling of personal fulfillment.

For an educational and career-development purpose, it is preferred that the method comprises as self-awareness, self-esteem and confidence attributes the following: confidence, strengths awareness, self-contentedness, skills awareness, clarity of goals, motivation to achieve, knowledge of desired study subjects, can do attitude, knowledge of how to prepare a CV, awareness of suitable jobs/careers, self belief, and positivity about accomplishments.

As mentioned above, the method comprises at least five steps: establishing a baseline measurement, identifying from the baseline attributes in need of improvement or most in need of improvement, providing and/or facilitating in means or methods designed or intended to address the said improvement needs, establishing a revised measurement of the attributes and comparing a revised measurement with a baseline measurement to identify a change.

The establishment of a baseline measurement is achieved, preferably, by presenting to the individual a series of self-awareness, self-esteem and confidence specific questions or statements, which questions or statements require multiple choice or graded responses (e.g. as a value from 1 to 10). A series of values may be attributed to the self-awareness, self-esteem and confidence attributes according to the answers given and the values recorded. The questions or statements are preferably presented to an individual through a networked or internet connection to an individual's interface from a remote server, e.g. via a personal account for an individual user. The responses may then be stored on a data storage device associated with the remote server as a dataset tagged to the user. A baseline measurement dataset is typically translated to a visual representation, preferably a spider diagram.

After completion of training or exercises designed to address or improve self-awareness, self-esteem and confidence attributes (which will be discussed in more detail below) or after a period of time in which such exercises are expected to be completed, a revised measurement of self-awareness, self-esteem and confidence attributes in the individual is conducted. This is typically achieved by requiring the user on logging in after a particular time or on completion of a particular exercise to complete a revised self-awareness, self-esteem and confidence attributes questionnaire. A dataset of revised figures is generated and may be stored as a revised (e.g. labeled successively or according to date of completion) dataset again tagged to the individual user. The revised measurement dataset, again, is typically translated to a visual representation, preferably a spider diagram. Any change in the individual's ratings self-awareness, self-esteem and confidence attributes can be determined from the difference between the respective values in the revised and baseline (or earlier revised) datasets. This change can be represented in a visual form such as a spider diagram showing the earlier and later datasets. Thus, the effect on self-awareness, self esteem and confidence attributes of certain training exercises or techniques or training styles may be measured. Accordingly, the training in such soft skills may be a more accountable activity.

Optionally, the measurement datasets or visual representations of them may be presented to the individual and/or a tutor or coach of the individual to provide information on the initial position and of progress. Preferably the self-awareness, self-esteem and confidence attribute baseline and improvement data is made available to the tutor or coach.

Self-awareness, self-esteem and confidence attribute datasets from multiple individuals may be stored in a data storage device or database associated with a remote server typically. Each dataset is tagged to the individual whose personal account in the system of the invention was used in generating the data. Typically, an individual user's account may be tagged to groups or organizations or other specified label. For example, an individual may be tagged to a group, such as a tutor or coaching group or class, to a year group at a school, college or university, to an organization, business or institution (e.g. a school or college), to a tutor or coach responsible for certain training activities and/or to a specified geographic area (e.g. a local authority area). Such plurality of datasets may be aggregated or combined in a manner which enables search and retrieval according to various criteria to do with the values in the dataset, optionally in combination with values associated with tagged groups or information. The aggregation or combination of data may be according to any specified mechanism, typically from mean, mode or median or may incorporate additional features.

For example, the database may be mined by a tutor to identify the lowest scoring attributes in a predefined (tagged) group, e.g. the tutor's tutor group. This will allow the system to identify, say, the lowest three scoring skills or attributes in the group for the purpose of prioritizing the scheduling of training. Optionally, the data may be manipulated according to a pre-determined criterion if, for example, a selection of training courses are available for prioritization from which some training courses are applicable to only one attribute whereas another training course may be applicable to multiple attributes. In another example, there may be intended to schedule a training workshop in a particular topic that is designed to enhance one or more of the self-awareness, self-esteem and confidence attributes. A tutor may mine the system for individuals in, e.g. an institution, who have a lower than average score in that institution in order to target the workshop at those individuals.

A further utility of the system and method of the present invention is, in addition to identifying individuals in need of specific training assistance or identifying individuals most in need of a certain training support and identifying the improvement in individuals, the monitoring of effectiveness of training and/or the monitoring of effectiveness of tutors or coaches. The effectiveness of training or coaching is essential to know in allocating resources to training or coaching. It is also useful in recruitment of tutors/coaches to carry out such training. By mining the database of baseline and revised (and later revised) measurements of attributes, the improvement in a particular attribute across a group may be measured in response to a training exercise designed to improve the attribute. Likewise, the performance of one tutor or coach in delivering training exercises designed to improve an attribute may be compared in terms of the improvement in measurement of the attributes of the individuals trained by each tutor or coach.

In any educational, business or personal environment, an awareness of one's attributes and learning behavior and learning motivation can help an individual understand that they are good at some types of activity and less so at others and that they are motivated to participate and achieve by different factors. Formal educational establishments have largely failed to respond to the need for understanding the learning behavior and learning needs of the individual (and groups) with the consequence that many individuals feel a lack of worth and feel disenfranchised from the education system. Training in self-awareness, self-esteem and self-confidence attributes and in identify learning behaviours and learning motivations is very under-represented and is difficult to assess. The present invention provides a means for identifying and improving the attributes through a structured approach and for measuring the improvement in such attributes among individuals or a group of individuals. This it is believed leads to improved self-esteem and self-worth amongst certain individuals and better decision making (by aligning decisions, e.g. about study and career choices, with what the individual knows about themselves through increased self-awareness).

As mentioned above, one step in the method of the invention is the providing to and/or facilitating the individual (or group of individuals) one or a plurality of self-awareness, self-esteem and confidence raising exercises or learning modules designed to address the self-awareness, self-esteem and confidence attribute improvement needs of the individual (or group of individuals). The self-awareness, self-esteem and confidence raising exercises or learning modules may be any suitable such learning modules, e.g. that are commercially available, and may involve online or off-line working, workshops with teachers or interactive group work (online or offline). In one embodiment of the invention, the learning and instructional materials may be stored in a database associated with the system server and, responsive to a perceived learning need of an individual (e.g. if an attribute score is below a pre-determined threshold, or on selection by a tutor from a query), sent to the individual by way of an email or message to their personal account in the form of attachments or download or login link to the materials. Optionally, a tutor will be prompted to respond online when the individual begins the exercises or reaches a pre-determined checkpoint.

Preferably, the exercises or modules may be selected from those designed or intended to improve one or more of confidence, strengths awareness, self-contentedness, skills awareness, clarity of goals, motivation to achieve, knowledge of desired study subjects, can do attitude, knowledge of how to prepare a CV, awareness of suitable jobs/careers, self belief, and positivity about accomplishments.

In a preferred embodiment, the exercise or learning module comprises a learning behavior and/or learning motivation exercise whereby the individual may explore their own learning behaviours and learning motivations. Preferably, the exercise comprises the individual completing one or more questionnaires designed to identify and categorise the individual's behaviour and motivational characteristics, of which there are commercially available examples. Examples of commercially available behavioural and motivational profiling exercises include Myers Briggs™ profiling, Belbin's™ team roles, Carl Jung's personality types, Keirsy's Temperament Sorter, Hans Eysenck's personality types theory and FIRO-B™ Personality Assessment model as well as models such as PIAV and others relating to Gordon Allport's study of values assessment.

Preferably, the exercise or module is designed to explore and categorise the individual according to a behavioural profile and/or a motivational profile. It is preferred that at least a motivational profile is generated.

Preferably the exercise, questionnaire and profile intended to explore and categorise the individual's behavioural characteristics produces a profile which categorises the individual by a matrix of values and/or single value associated with the categories: results/action orientated; involvement/fun orientated; methodical/teamwork orientated; and factual/detail orientated (or equivalent thereof). Preferably, an individual undertaking this exercise or module does so by logging into their personal account in the system and selecting the behavioural characteristics module, which presents the individual via the user interface with a series of questions, each question comprising a plurality of statements from which the individual may select only one which they believe most closely represents their behavior. Each answer has associated with it a value or position in a matrix which may be stored, the full set of answers providing a behavioural dataset which is stored in a data storage device associated with the system server and tagged to the user. From the behavioural dataset, the system may generate a user behavioural profile report for viewing by the user (and review by the user) optionally in the form of a downloadable report, or in electronic form whereby the user may indicate agreement or disagreement with statements made in the report (and said agreement or disagreement may be used to adapt the behavioural dataset tagged to that individual). From the dataset, the system may generated a learning behavior matrix, which comprises a four quadrant representation of the learning behavior categories with a two-dimensional web indicating the individual's learning behavior inclinations. The data associated with the learning behavior matrix may be utilized for comparison purposes. The individual is preferably categorized as one of four (or combination of) Primary Learning Behaviour (PLB).

Preferably the exercise, questionnaire and profile intended to explore and categorise the individual's motivational characteristics produces a profile which categorises the individual by a matrix of values and/or single value associated with the categories: discovery/understanding orientated; practicality/efficiency orientated; creativity/artistic orientated; supporting/helping orientated; competing/winning orientated; and ordering/organizing orientated (or equivalent thereof). Preferably, an individual undertaking this exercise or module does so by logging into their personal account in the system and selecting the motivational characteristics module, which presents the individual via the user interface with a series of questions, each question comprising a plurality of statements from which the individual may select only one which they believe most closely represents their motivations. Each answer has associated with it a value or position in a matrix which may be stored, the full set of answers providing a motivational dataset which is stored in a data storage device associated with the system server and tagged to the user. From the motivational dataset, the system may generate a user motivational profile report for viewing by the user (and review by the user) optionally in the form of a downloadable report, or in electronic form whereby the user may indicate agreement or disagreement with statements made in the report (and said agreement or disagreement may be used to adapt the motivational dataset tagged to that individual). From the dataset, the system may generate a learning motivation matrix, which comprises a six sector representation of the learning motivation categories with a two-dimensional web indicating the individual's learning motivation inclinations. The data associated with the learning motivation matrix may be utilized for comparison purposes. The individual is preferably categorized as one of six (or combination of) Primary Learning Motivation (PLM).

Preferably the Learning Behaviour and/or Learning Motivation data is stored in a database or data storage device associated with the system server and tagged to the individual for search and retrieval purposes. Preferably, the data and in particular the PLB and/or PLM may be searched by a tutor/coach, administrator or other authorized party in addition to the self-awareness, self-esteem and confidence attributes for the purpose of skill/attribute development training/tuition planning and group selection.

For example, a tutor may request retrieval of a list of individuals who would benefit from a particular course in a particular style, which may be scheduled. Accordingly, for example, the tutor may request identification of individuals tagged to a group who have scored lower than average for the group in ‘awareness of suitable careers’ and who have a PLM of competing/winning orientated and be provided with a list of names and, optionally, a recommended training module, whereby individuals having a specific attribute or skill learning need may be invited or facilitated with a training exercise/module designed to meet that need and presented in a manner that is receptive by individuals having that PLM. Accordingly, focused and tutee-specific training modules can be delivered for maximum effect and with minimal disruption.

In another aspect of the invention, which is mentioned above, is a method of identifying an aggregate or cumulative primary learning behaviour and/or primary learning motivation of a group of individuals, the method comprising retrieving from each individual in the group responses to an online or computer network accessed questionnaire, electronically storing the responses tagged to personal accounts allocated to each individual as individual behavioural data and/or individual motivational data, and either (or both of):

analyzing the behavioural and/or motivational data for each individual according to a set of predetermined criteria or predetermined matrix to categorise each individual according to a primary learning behaviour and/or primary learning motivation category and determining the most common primary learning behavior and/or primary learning motivation category in the group; or

aggregating the behavioural and/or motivational data to create a group profile data set (e.g. by mean, mode or median), analyzing the said aggregated group profile data set to according to a set of predetermined criteria or predetermined matrix to categorise the group according to a primary learning behaviour and/or primary learning motivation category.

The behavioural and motivation data may be obtained in a manner similar to that set out above. There is provided a system for obtaining said data, storing said data and collating and mining said data for retrieval according to a query or pre-defined criteria, the system comprising a server configured for access over a network or the internet via a personal account by a user from an interface remotely located relative to the server and comprising a processor for executing one or more programs available for access by the user, whereby responsive to a user action on its personal account the user is presented in the form of an online questionnaire comprising a behavioural and/or motivational specific questions or statements requiring responses and being designed for establishing behavioural and motivational categorisation; the server comprising a means for storing an individual behavioural data set and/or an individual motivational data set established according to the responses submitted by the user which data sets are tagged to the user's personal account; the server and associated processor configured to, on receipt of a plurality of individual behavioural and/or motivational data sets each tagged for the individual, collate said data sets to enable analysis of behavioural and/or motivational matrices for commonality and/or allocation to each individual an primary learning behavior and/or primary learning motivation categorization, said plurality of datasets and categorizations being searchable and retrievable according to pre-defined criteria.

Accordingly, a tutor or coach may enter a query to mine data for individuals within a group having a PLM and/or PLB compatible with a particular teaching style. Further, a tutor or coach may enter a query to mine data for individuals with a PLM and/or PLB that would allow them to form effective groups.

Further, a tutor or coach may, for a pre-determined group, identify the cumulative or aggregate primary learning motivation and/or primary learning behavior for the group to identify the most appropriate training approach for the group and further identify individuals within that group whose PLM and/or PLB is such that they are unlikely to be receptive to said training approach and adapt accordingly.

It is a further aspect of the invention that a method of selecting from a plurality of individuals a group of individuals having a specified selection or spectrum of primary learning behavior and/or primary learning motivation for the purpose of assembling a training group or a work group, the method comprising retrieving from each individual in the group responses to an online or computer network accessed questionnaire, electronically storing the responses tagged to personal accounts allocated to each individual as individual behavioural and/or motivational data, analyzing the individual behavioural and/or motivational data for each individual according to a set of predetermined criteria or predetermined matrix to categorise each individual according to a primary learning behaviour and/or primary learning motivation category, storing said category data tagged to respective individuals, searching the individual category data according to specified selection or spectrum requirements, receiving a list of names corresponding to the searched data and inviting individuals from the list of names to form into a group.

Accordingly, there is provided as a further aspect of the invention a searchable database of behavioural and/or motivational data sets and/or PLM and/or PLB categorisations for individuals and/or groups of individuals said data sets and/or categorisations tagged to specific identifiable individuals and/or groups of individuals.

In another aspect of the invention there is provided an online resource for computer aided learning, the resource comprising a system server configured for allocating a plurality of personalized accounts for registered users and comprising access to a plurality of learning materials and configured to retrieve and store a data set of behavioural and/or motivational data tagged for each personalized account, which data for the plurality of personalized accounts is collated for data mining according to a set of pre-defined requirements; the system capable of providing learning materials to a user in a requested topic in a style dependent upon the tagged behavioural and/or motivational data set.

In using the aforementioned resource for computer aided learning, an individual on first login to a personal account is required to complete a questionnaire designed to retrieve a data set of behavioural and/or motivational data to be tagged for user's personal account, whereby the user may be recommended learning aids according to their learning behaviours and/or learning motivations (e.g. as categorized by their PLB and/or PLM).

The system, resource and method may further allow a profile to be submitted comprising information about the user's interests, learning objectives etc. The resource may require the user to seek learning materials according to a specific subject or curriculum of subjects or learning objectives and may recommend, according to the user's behavioural and/or motivational data set, a specific learning material for that subject or learning objective designed or effective for enhanced learning by user's with a common behavioural and/or motivational data set or characteristic.

Optionally, in use, a user may seek assistance from a tutor or coach if a difficulty is faced in comprehending or progressing through the learning material. In one embodiment, the tutor or coach, who may be patched on request by video link or via online chat or messenger, is selected or identified according to certain tutoring or coaching criteria. Preferably the criteria include subject matter knowledge and PLM and/or PLB style alignment. The PLM and/or PLB style alignment criterion may depend upon one or more factors such as: the tutor/coach's teaching style as retrievable from a behavioural and/or motivational data set tagged to said tutor/coach's personal account, an aggregate of ratings given by other individuals whom that tutor/coach has assisted (and in particular such other individuals having a common PLM and/or PLB), and where a learning material is associated with an assessment, the performance of individuals in such an assessment that have had assistance from a particular tutor/coach relative to other tutors/coaches. Preferably, a further tutor identification criterion is previous experience and/or rating by the same individual.

Accordingly, a tutor/coach may be allocated to the individual who is likely to make a bigger difference to the learning experience of the individual.

In a further embodiment, the learning resource (which is preferably a networked resource, e.g. available by subscription) may be an interactive learning resource whereby an individual user may engage in group work or discussion with other users of the resource. According to this embodiment, individuals may be recommended or retrieve in a search another user according to learning behavior and/or learning motivation data sets and/or categorization and optionally also profile data such as interests, learning objectives, study programme and/or curriculum. Accordingly, two individuals with compatible learning styles and motivations may engage in group work and/or discussion more effectively. For example, individuals with certain learning motivations and behaviours are more likely to tackle the problems of learning a language in the same way (e.g. a give it a go, conversational style) than other individuals with different learning motivations and behaviours (who may prefer, for example a studious style with numerous tests). It is beneficial to the learning of both parties to be paired with a co-learner whose style is matched with their own.

In certain circumstances, it is beneficial to have different PLB and/or PLM types in a group for achieving a group project (as different types will have different strengths). Accordingly, a searchable database of PLB and/or PLM data tagged to individual personal accounts may be utilized to establish effective groups for an online project or otherwise in education, business or personal matters.

It is a further embodiment that a behavioural and/or motivational data sets tagged to individual personal accounts on an online resource may be utilized to match individuals with characters (especially learning behavioural and/or learning motivational characteristics) that are complementary, since it is likely that such individuals may have more in common in their view of the world and are more likely to get on. Accordingly, social and other networking sites such as Facebook™ or Linked In™ may utilize such PLM data.

The invention will now be described in more detail without limitation, with reference to the accompanying Figures.

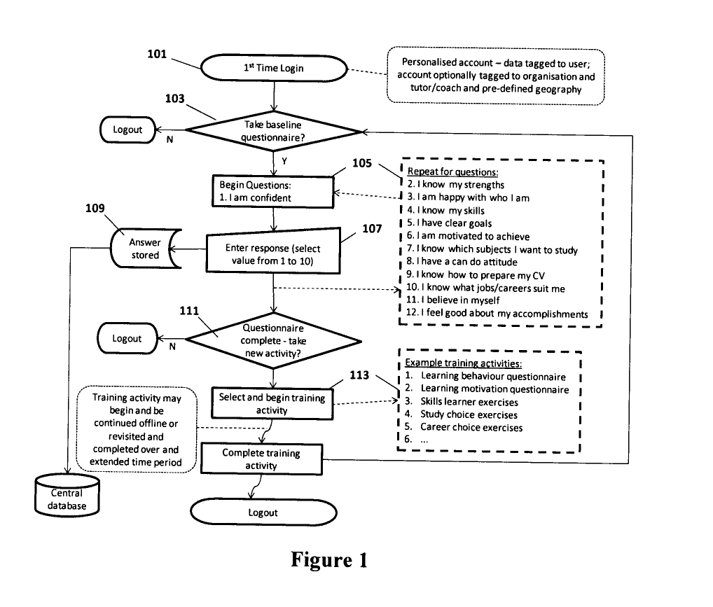

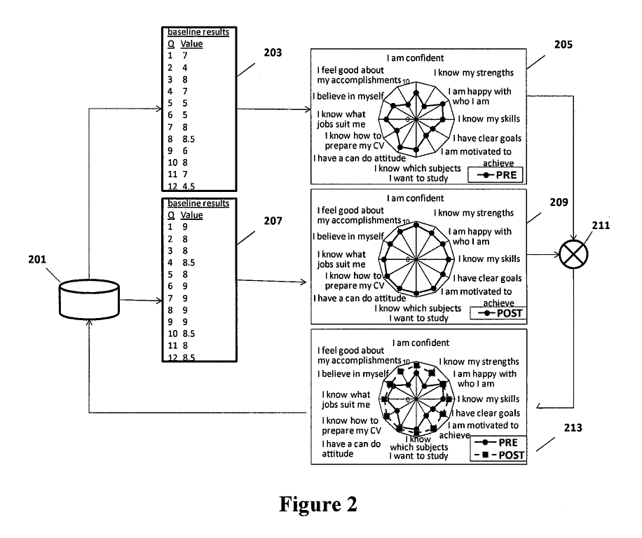

In FIG. 1, a process according to the method of the present invention is illustrated. According to the process a user registers for or conducts a first time login 101 to a personal account on a server via a user interface to gain access to a system and is first presented with an option to take a baseline questionnaire 103. On selecting the baseline questionnaire, the user is presented with a series of questions or statements in turn from a list of self-awareness, self-esteem and confidence attribute specific questions or statements 105 and required to select a grade 107 relating to the degree that each question or statement applies to the user, typically from a range 1 to 10. The answers are stored 109 as a series of values representing the user's baseline measurement data. Automatically, or upon request by a tutor or coach, the user's baseline measurement data 203 is converted into a visual representation 205 of the user's baseline measurement of self-awareness, self-esteem and confidence attributes as shown in FIG. 2, which data and visual representation is retrievable by or sent to the user's tutor or coach (as tagged to the user's personal account) by email for example.

The user may log out or continue 111. Optionally, the user may select a further exercise according to several categories 113, such as a self-belief development module, a goals-identification module, development of can-do attitude, a CV writing module, or other module for developing soft skills etc. Alternatively, the tutor or coach may suggest or recommend a skills development module for the user, e.g. by supplying a recommendation to their account (which will be highlighted next time they log on) and/or by email.

The user then completes one or more soft-skill development modules. The user may choose to provide an updated attribute measurement via the system at any time, or may be required to do so according to a pre-determined time, or more likely, may be required to do so on request of the tutor/coach. A second measurement 207 will be recorded and may be presented in visually representative form 209 (FIG. 2). If two measurements have been performed, a baseline measurement and a revised measurement, the system calculates the improvement 211, reports the improvement to the tutor/coach and presents the improvement in a visually representative format 213. Optionally, improvement data may be calculated from raw data on database 201 each time it is requested, or performance and improvement data and representations can be stored in the database 201.

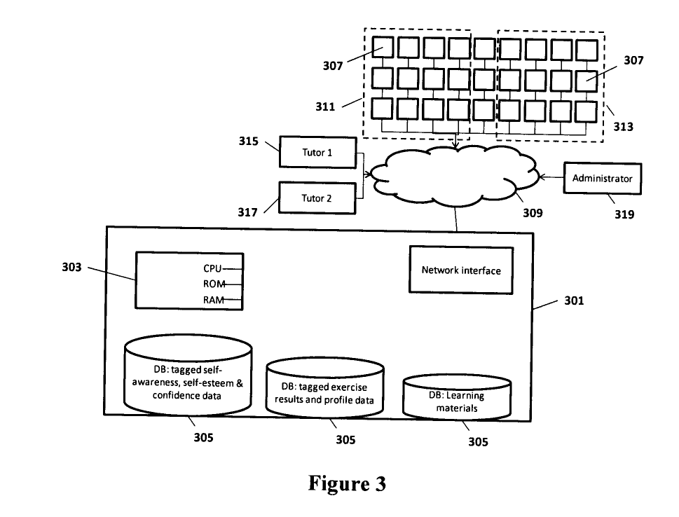

FIG. 3 illustrates a system for putting the invention into effect, the system comprising a server 301 having a processor 303 configured to the server and an associated storage device for storing server functions available to a user including one or more databases 305 comprising, for example, tagged self-awareness, self-esteem and confidence data from the baseline and revised questionnaire answers by users, tagged exercise results and profile data of the users and learning materials and exercises available to the users. Individual users 307 may access the system through user interfaces linked to the server by a network communication means 309, such an internet connection. Each user 307 accesses the system by a personal account and all the data associated with the user 307 is tagged to the user 307. Further, if the user 307, as is typical, is associated with a larger group 311, 313 (e.g. one or more of a tutor group, an institution or business or a pre-defined geographic group), their data is tagged to that one or more group. Data associated with a plurality of users may be searched, e.g. by a tutor 315, 317 or a system administrator 319. For example, a tutor such as Tutor 1 315 may search amongst the self-awareness, self-esteem and confidence data of a group such as Class 1 311 to identify students who have scored themselves lower than say 6 for ‘I believe in myself’ in order to invite such students to a self-belief building workshop or to invite such students to undertake a web-based individual or group exercise. Alternatively, a tutor 315 may mine the data for their group to identify a proportion of users 307 having the relatively lowest scores for a particular attribute (or other tagged exercise or profile data) within a group 311. Alternatively, the data may be mined to identify the attribute, skill or learning requirement most in need for the group as a whole.

An administrator 319, may monitor the performance not only of individual students, but, say of a tutor 315, by comparing the performance of a tutor 315 over a pre-defined period of time (using e.g. a visual representation of improvement of the group as an average in a format of 213) with another tutor 317. Accordingly, tutor performance can be assessed (as reflection of average user performance) over a period of time. Similarly, the performance of institutions in so far as it relates to a particular measurable associated with its training efforts may be assessed and compared.

The server 301 may be provided with several functions which may be configured as computer programmes for facilitating the operation of the system include a questionnaire function, data collator for collating data set tagged for the user and aggregated data of determinable information and data-mining function.

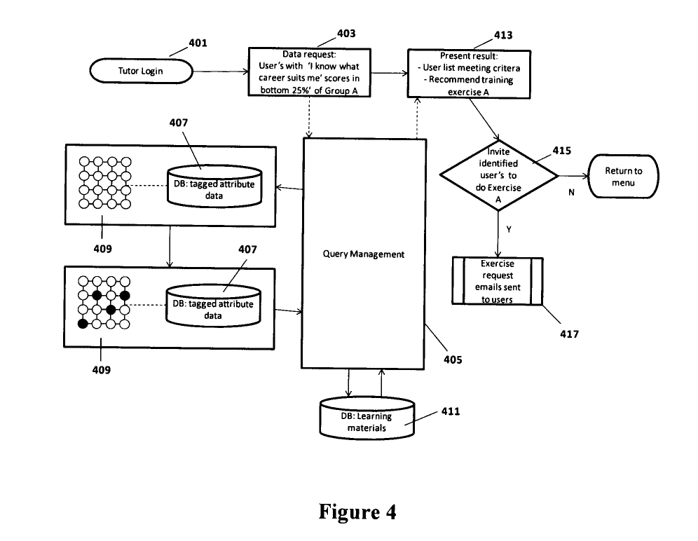

FIG. 4 illustrates a process for selecting individuals according to predetermined criteria according to their attribute data. A tutor/coach logs in 401 and makes a request 403 for the names of individuals, tagged to the tutor's group of sixteen students, whose ‘I know what career suits me’ scores in the baseline attribute measurement were in the bottom 25% of the group. The request is referred to a Query Management function 405 of the system server (not shown) which mines data in the database 407 among tagged datasets 409 for the group.

The query identifies four users from the initial sixteen. At the same time, the Query Management function 405 mines a database of learning materials 411 for exercises for designed for improving low scores in the queried attribute. The results, a list of users meeting the defined criteria and an exercise from the database for improving low scores in the defined attribute are presented 413. The tutor is then asked if they wish to invite the identified students to participate in the identified exercise 415 and if positive, an invitation is emailed to the users 417.

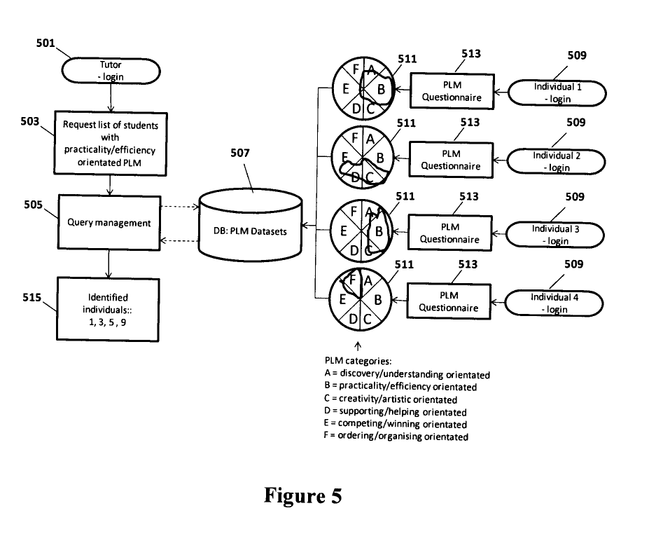

FIG. 5 illustrates a process for selecting individuals or students having a certain primary learning motivation for allocation to a teaching stream adapted for the certain primary learning motivation type. A tutor logs in 501 to the system and selects a request for students with a specified PLM 503. A query management function 505 addresses the question by mining a Database of PLM datasets 507 of a number of individuals 509 with personal accounts. The PLM datasets are made up of tagged datasets corresponding to learning motivation matrix data, visually represented in 511, assimilated from PLM questionnaires 513. A Primary Learning Motivation category (of 6, typically) is derived from the learning motivation matrix data and the query management function delivers a list of individuals meeting the requested criterion 515. The teacher may then invite the specified individuals to participate in a training exercise or course developed for their learning motivation type.

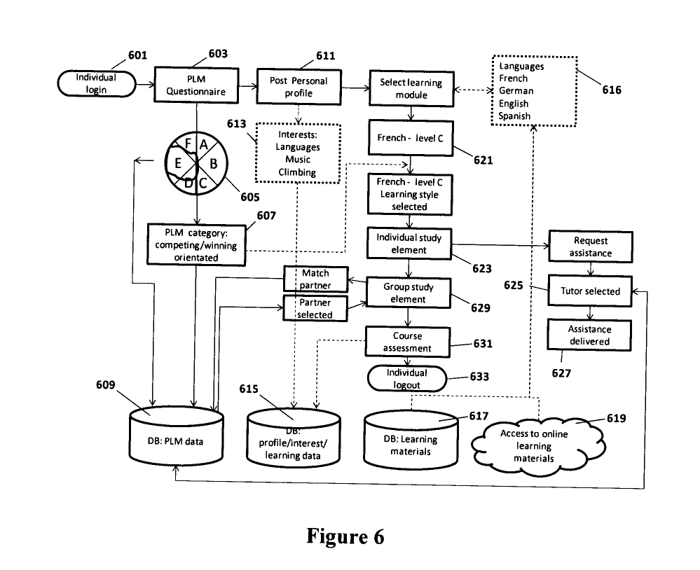

FIG. 6 illustrates an interactive computer-aided learning system from first log-in of the user. An individual user logs in 601 to its personal account. Before it can access learning material, the user is required to complete a PLM questionnaire 603 (and optionally an PLB questionnaire), which produces a learning motivation data matrix 605, from which a PLM categorization 607 is derived. The PLM category 607 and matrix data 605 are stored in a system storage device or database 609 (typically on a web-interfaced server, not shown). The user may then post personal profile data 611 for publishing on a personal profile page on the learning resource, e.g. they may post a list of educational and personal interests 613, which are stored in a database 615 for profile, interests and learning data. The individual may then browse a list of available learning materials 616 according to a category of learning (e.g. languages), which learning materials may be available from a database or data storage device 617 associated with the remote server or via a web-interface to affiliated sites carrying learning materials 619. A learning material subject matter is selected (French level C) 621 and the system automatically recommends a course delivering the subject matter in a learning style according to the individual's PLM category. In this case, the individual has been identified as having a competing/winning orientated PLM category. Accordingly, the teaching style provided includes intense learning activities with frequent and challenging testing in a clearly structured programme of individual study 623. In the event of getting stuck, the individual may request assistance.

The system mines data of available tutors for a suitable contact, selected from availability, subject matter expertise, and teaching/learning style alignment with individual's PLM. A tutor is identified and connected 625 and assistance delivered 627. A group work element 629 is then progressed and the system recommends a study partner for the individual by mining PLM data in the PLM database for one or more partners studying the same course with a compatible PLM. The partners can communicate by live chat or instant messaging in attempting to complete the group tasks. An assessment 631 is carried out and the user then logs out 633.

Optionally, the means of identifying and matching a tutor/coach whose style the individual/student will likely be receptive to may be applied in a face-to-face environment, whereby a web or network-based system allows the matching of motivations or primary learning motivations for an individual or group of individuals, with a tutor's teaching style or previous success/recommendation by individuals/students with that primary learning motivation. This may be used, for example, for providing each individual in an organization with a mentor or coach for approaching with problems or difficulties (which may be subject-specific).

The invention has been described with reference to preferred embodiments. However, it will be appreciated that variations and modifications can be effected by a person of ordinary skill in the art without departing from the scope of the invention.

1. A method for facilitating the development and monitoring of self-awareness, self-esteem and confidence attributes in an individual, the method comprising the steps of
establishing a baseline measurement of self-awareness, self-esteem and confidence attributes in the individual by presenting the individual a series of self-awareness, self-esteem and confidence specific questions or statements requiring multiple choice or graded responses and recording the responses;
identifying from the baseline measurement specific self-awareness, self-esteem and confidence attributes in need of improvement;
optionally communicating the specific self-awareness, self-esteem and confidence attribute improvement needs identified to the individual or a teacher or coach thereto;
providing to and/or facilitating the individual one or a plurality of self-awareness, self-esteem and confidence raising exercises or learning modules designed to address the self-awareness, self-esteem and confidence attribute improvement needs of the individual;
establishing a revised measurement of self-awareness, self-esteem and confidence attributes in the individual by presenting the individual a series of self-awareness, self-esteem and confidence specific questions or statements requiring multiple choice or graded responses and recording the responses; and
comparing the revised measurement with the baseline measurement and reporting any change.

2. A method according to claim 1 wherein the self-awareness attributes, self-esteem and confidence are selected from one or more of confidence, strengths awareness, self-contentedness, skills awareness, clarity of goals, motivation to achieve, knowledge of desired study subjects, can do attitude, knowledge of how to prepare a CV, awareness of suitable jobs/careers, self belief, and positivity about accomplishments.

3. A method according to claim 1, wherein the self-awareness, self-esteem and confidence attributes comprise all of those specified in claim 2.

4. A method according to claim 1 which further comprises collating the baseline measurements of a plurality of individuals.

5. A method according to claim 4 in which a group baseline measurement is established for the plurality of individuals and wherein the identification of specific self-awareness, self-esteem and confidence attributes in need of improvement is made in respect of the group baseline measurement and/or in respect of an individual baseline measurement relative the group baseline measurement.

6. A method according to claim 1 or claim 5, wherein the self-awareness, self-esteem and confidence attributes in need of improvement are identified according to a set of pre-determined criteria.

7. A method according to claim 1 or claim 5, wherein a plurality of individuals are identified that meet a set of predetermined criteria in terms of self-awareness, self-esteem and confidence attributes in need of improvement, which plurality of individuals may be provided with one or a plurality of specified self-awareness, self-esteem and confidence raising exercises or learning modules.

8. A method according to claim 1 in which the revised measurement of self-awareness, self-esteem and confidence attributes is established using the same series of self-awareness, self-esteem and confidence specific questions or statements used to establish the baseline measurement.

9. A method according to claim 4 which further comprises collating the revised measurements of a plurality of individuals, whereby the comparison of the baseline measurement and revised measurement and reporting of change may be made for the plurality of individuals as a group.

10. A method according to claim 1, wherein the one or a plurality of self-awareness, self-esteem and confidence raising exercises or learning modules designed to address the self-awareness, self-esteem and confidence attribute improvement needs of the individual includes a behavioural profiling exercise and/or a motivational profiling exercise which exercises comprise presenting to the individual a series of questions or statements specific to deriving behavioural and/or motivational information, storing and analyzing responses provided, generating and presenting to the individual a personal profile which includes statements relating to expected behaviour and/or motivation of the individual and having exercises for the individual to confirm or disregard said statements themselves and/or with colleagues/peers whereby the individual gains a greater understanding of their behaviours and/or motivations.

11. A method according to claim 10 which further comprises deriving from said responses or said profile a primary learning behaviour and/or a primary learning motivation for the individual.

12. A method according to claim 1, wherein the one or a plurality of self-awareness, self-esteem and confidence raising exercises or learning modules designed to address the self-awareness, self-esteem and confidence attribute improvement needs of the individual may be selected from a study module configured to assist the individual in understanding their skills or the applicability of their skills, primary learning behaviours and/or primary learning motivations to study and/or career choices.

13. A method according to claim 1, wherein the individual is a school or college student, preferably in the age range 11 to 18.

14. A method according to claim 1, wherein the individual is presented the series of self-awareness, self-esteem and confidence specific questions or statements through a networked or internet connection to the individual's interface from a remote server and storing, analyzing and reporting the results via the remote server or configured central processing unit.

15. A system for facilitating the development and monitoring of self-awareness, self-esteem and confidence attributes in an individual user according to the method of claim 1, the system comprising
a server configured for access over a network or the internet via a personal account by a user from an interface remotely located relative to the server and comprising a processor for executing one or more programs available for access by the user, whereby responsive to a user action on its personal account the user is presented in the form of an online questionnaire comprising a series of self-awareness specific questions or statements requiring multiple choice or graded responses;
the server comprising a means for storing an initial data set submitted by the user in response to the questionnaire and one or more successive data sets submitted by the user in successive responses to the questionnaire, which initial data set and successive data sets are tagged to the user's personal account;
the server and associated processor configured to, on receipt of an initial and each successive data set, identify from said data set specific self-awareness attributes in need of improvement according to a predetermined scale or matrix and providing to and/or facilitating and/or prompting the user to undertake one or a plurality of self-awareness raising exercises or learning modules designed to address the self-awareness, self-esteem and confidence attribute improvement needs of the user;
and further configured on receipt of each successive data set, produce a comparative data set according to predetermined comparison criteria and to generate a report indicating identified changes.

16. A system according to claim 15, wherein the server is configured to allow the user to complete a behavioural profiling exercise and/or a motivational profiling exercise, which on the user electing to complete such exercise, the server is configured to present the user with an online questionnaire comprising a series of questions or statements specific to deriving behavioural and/or motivational information, to analyse responses provided and to generate and present to the user a profile report which includes statements relating to expected behaviour and/or motivation of the user and to store as behavioural and/or motivational profile data the user responses and the profile report; the server further configured to, according to the responses provided, categorise the user according to the user's primary learning behavior and primary learning motivation which are derivable according to a predetermined matrix or formula and to store the categorization data, wherein the profile data and categorization data are tagged to the user's personal account.

17. A system according to claim 15, wherein a user's personal account and the data tagged thereto is further tagged according to a user's teacher and/or peer group and/or institution or organization whereby an authorized person may access data tagged to the teacher and/or peer group and/or institution or organization as individual user data and/or aggregated user-group data and optionally search individual user data and/or aggregated user-group data to retrieve the identity of individuals in need of specified assistance (according to pre-determined criteria), or aggregate improvement performance data of a user group by teacher and/or institution and/or topic of study.

18. A method of identifying an aggregate or cumulative primary learning behaviour and/or primary learning motivation of a group of individuals, the method comprising retrieving from each individual in the group responses to an online or computer network accessed questionnaire, electronically storing the responses tagged to personal accounts allocated to each individual as individual behavioural data and/or individual motivational data, and either (or both of):
analyzing the behavioural and/or motivational data for each individual according to a set of predetermined criteria or predetermined matrix to categorise each individual according to a primary learning behaviour and/or primary learning motivation category and determining the most common primary learning behavior and/or primary learning motivation category in the group; or
aggregating the behavioural and/or motivational data to create a group profile data set (e.g. by mean, mode or median), analyzing the said aggregated group profile data set to according to a set of predetermined criteria or predetermined matrix to categorise the group according to a primary learning behaviour and/or primary learning motivation category.

19. A method according to claim 18, wherein the individual is a student and the group is a student group.

20. A method according to claim 18, wherein the primary learning motivation categories are: discovery/understanding orientated; practicality/efficiency orientated; creativity/artistic orientated; supporting/helping orientated; competing/winning orientated; and ordering/organizing orientated and/or wherein the primary learning behavior categories are: results/action orientated; involvement/fun orientated; methodical/teamwork orientated; and factual/detail orientated.

21. A method according to claim 18, which further comprises preparing adapted course or lesson formats for the group of individuals to best suit the identified aggregate primary learning behaviour and/or primary learning motivation of the group of individuals according to a predetermined teaching methodology options.

22. A method according to claim 18, which further comprises identifying from the behavioural and/or motivational data for each individual, those individuals whose primary learning behavior and/or primary learning motivation category diverges from the identified group primary learning behavior and/or group primary learning motivation according to a predetermined set of rules whereby the divergent individual(s) are deemed likely to be unreceptive to a teaching environment designed for the group primary learning behavior and/or group primary learning motivation or have an unsatisfactory learning experience in that environment and/or to cause boredom and/or disruption to teaching.

23. A method according to claim 22, wherein measures are taken to address learning needs of divergent individuals by reallocating the divergent individuals to a group with which their primary learning behavior and/or primary learning motivation category accords according to a predetermined set of rules or providing specific exercises and/or instruction within the teaching environment of the group to satisfy their primary learning behavioural/motivational category.

24. A method of selecting from a plurality of individuals a group of individuals having a specified selection or spectrum of primary learning behavior and/or primary learning motivation for the purpose of assembling a training group or a work group, the method comprising retrieving from each individual in the group responses to an online or computer network accessed questionnaire, electronically storing the responses tagged to personal accounts allocated to each individual as individual behavioural and/or motivational data, analyzing the individual behavioural and/or motivational data for each individual according to a set of predetermined criteria or predetermined matrix to categorise each individual according to a primary learning behaviour and/or primary learning motivation category, storing said category data tagged to respective individuals, searching the individual category data according to specified selection or spectrum requirements, receiving a list of names corresponding to the searched data and inviting individuals from the list of names to form into a group.
